(19) United States
(12) Patent Application Publication
(10) Pub. No.: US 2025/0389086 A1
(43) Pub. Date: Dec. 25, 2025

(54) A method, a moulded multi-layered fibrous product, and use thereof

(71) Applicant: Metsä Spring Oy, Espoo (FI)

(72) Inventors: Emilia Vänskä, Espoo (FI); Jarkko Tuominen, Espoo (FI)

(21) Appl. No.: 18/880,283

(22) PCT Filed: Oct. 19, 2023
(86) PCT No.: PCT/FI2023/050593

§ 371 Date: Dec. 31, 2024

(30) Foreign Application Priority Data
Oct. 19, 2022 (FI) 20225944

(51) Int. Cl. D21H 27/38; B32B 1/00; B32B 29/00; D21H 11/04; D21H 17/09; D21H 17/17; D21H 17/55; D21H 21/16; D21H 21/20

(52) U.S. Cl. CPC D21H 27/38; B32B 1/00; B32B 29/005; D21H 11/04; D21H 17/09; D21H 17/17; D21H 17/55; D21H 21/16; D21H 21/20; B32B 2250/26; B32B 2307/718; B32B 2307/73; B32B 2439/70

(57) ABSTRACT

According to an example aspect of the present invention, there is provided a method comprising: in a mould, forming a multi-layered foamed fibrous structure from foamed fibrous compositions, wherein each of the foamed fibrous compositions comprises cellulosic fibres, water, air, and at least one foaming agent; dewatering the foamed fibrous structure; hot-pressing the dewatered structure, to obtain a moulded fibrous product, wherein said at least one foaming agent comprises at least one surface-active foaming agent and/or at least one polymeric foaming agent, and wherein at least one of the foamed fibrous compositions comprises a hydrophobic agent.

### FIELD

The present invention relates to moulded fibrous products.

### BACKGROUND

In the known technology for preparing moulded fibrous products, foam is deposited to a basin-like mould with a headbox. Due to separate forming and pressing sequences, the forming and dewatering processes are slow, and the foam may be spread unevenly within the mould. The method is suitable mainly for products like filters or insulators. Typically, the obtained structures, such as egg trays, are thick-walled (>500 μm), porous and the surface is non-homogeneous and rough. Moreover, foam forming results in larger pores in the moulded fibre product structure compared to water forming, and these pores impair internal and external barrier development of the products. Furthermore, due to a charged foam environment in the wet end, compatibility of the foaming agents and barrier additives is difficult to achieve.

Another known alternative is to use water-forming processes to prepare moulded fibrous products, but these processes are only suitable for moulding a single, substantially thin-wall layer at a time, making the process cumbersome if a more complex structure, such as a multi-layer structure, is desired. In addition, water formed moulded fibrous products often have a non-uniform structure, and floc formation is considerably increased with the fibre length and increasing furnish consistency, for example when trying to avoid excess water usage.

Barrier properties are known to be important for moulded fibrous products, especially in the case of food packaging. However, the microscopic roughness of moulded fibre surfaces obtained with moulding methods, and the fibres' natural water affinity present challenges with regard to barrier development. To overcome this, significantly higher amounts of sizing chemicals are typically required in moulding methods when compared to similar functional products produced for example from folding boxboard.

Furthermore, the curing time available for sizing agents is significantly shorter in thermoforming processes compared to conventional drying sections of paper and board machines and over-dosing sizing agent is not feasible.

The known technologies are also inadequate with regard to production of demanding geometries, such as variable-thickness walls or thin walls, deep drawing walls, rimming structures and low-friction surfaces.

It is an aim of the present invention to provide improved moulded fibrous products, particularly obtained by foam forming methods.

### SUMMARY OF THE INVENTION

The invention is defined by the features of the independent claims. Some specific embodiments are defined in the dependent claims.

According to a first aspect of the present invention, there is provided a method comprising: in a mould, forming a multi-layered foamed fibrous structure from foamed fibrous compositions, wherein each of the foamed fibrous compositions comprises cellulosic fibres, water, air, and at least one foaming agent; dewatering the foamed fibrous structure; hot-pressing the dewatered structure, to obtain a moulded fibrous product, wherein said at least one foaming agent comprises at least one surface-active foaming agent and/or at least one polymeric foaming agent, and wherein at least one of the foamed fibrous compositions comprises a hydrophobic agent.

According to a second aspect of the present invention, there is provided a moulded fibrous product obtained by the method according to the first aspect.

According to a third aspect of the present invention, there is provided use of the product according to the second aspect as a food or liquid packaging or a food or liquid serving product or as a part thereof, or in packaging, serving, storing, preparing, cooking and/or heating of food or liquid.

According to a fourth aspect of the present invention, there is provided use of a non-ionic polymer as a foaming agent and AKD as an internal sizing agent in the manufacturing of a moulded fibrous product or a part, such as a layer, thereof by a method comprising foam forming and subsequent hot pressing.

According to a fifth aspect of the present invention, there is provided a method comprising: in a mould, forming a multi-layered foamed fibrous structure from foamed fibrous compositions, wherein each of the foamed fibrous compositions comprises cellulosic fibres, water, air and a foaming agent; dewatering the foamed fibrous structure, for example after forming each layer; hot-pressing the dewatered structure, to obtain a moulded multi-layered fibrous product, in which method at least two different foaming agents are applied, wherein said at least two different foaming agents are selected, independently from each other, from the group of surface-active foaming agents and polymeric foaming agents.

According to a sixth aspect of the present invention, there is provided a moulded multi-layered fibrous product obtained by the method according to the fifth aspect, which product preferably is a food or liquid packaging or a food or liquid serving product or a part thereof.

Various embodiments of the first aspect and the fifth aspect may comprise one or more features from the following bulleted list:
Each layer is formed of a respective foamed fibrous composition.
Each foamed fibrous composition comprises, independently from each other, at least one surface-active foaming agent, such as an anionic surfactant, and/or at least one polymeric foaming agent, such as a non-ionic polymer.
At least two different foaming agents, such as at least three different foaming agents, for example at least four different foaming agents, are used in the method.
At least one of the foamed fibrous compositions comprises both a surface-active foaming agent and a polymeric foaming agent.
At least two of the foamed fibrous compositions, such as at least three of the foamed fibrous compositions, comprise both a surface-active foaming agent and a polymeric foaming agent.
At least two of the foamed fibrous compositions comprise different foaming agents.
The total amount of foaming agents in each foamed fibrous composition is in the range 0.1 to 35 wt-%, for example 5 to 20 wt-% or for example 1 to 3 wt-% or for example 0.1 to 1 wt-%, calculated from the weight of dry fibres in said foamed fibrous composition.
The total amount of anionic surfactants in the foamed fibrous composition comprising anionic surfactants is at least 0.1 wt-%, for example at least 0.5 wt-%, for example at least 1 wt-%, such as 0.1 to 1 wt-% or 1 to 5 wt-%, calculated from the weight of dry fibres in said foamed fibrous composition.
The foamed fibrous composition for at least one fibrous layer comprises at least 0.5 wt-%, for example at least 1 wt-%, for example at least 5 wt-%, such 5 to 35 wt-% of a non-ionic polymer as a foaming agent, calculated from the weight of dry fibres in said fibrous composition.
The foamed fibrous composition for at least one fibrous layer comprises at least 0.1 wt-%, for example at least 0.5 wt-%, for example at least 1 wt-%, such as 0.1 to 1 wt-% or 1 to 5 wt-% of an anionic surfactant as a foaming agent, calculated from the weight of dry fibres in said fibrous composition.
The amount of each foaming agent in the foamed fibrous composition is at most 1 wt-%, calculated from the weight of dry fibres in said fibrous composition.
Said at least one non-ionic polymer is selected from the following group: polyvinyl alcohol (PVA), polyethylene glycol dodecyl ether (Brij), polyethylene glycol sorbitan monolaurate (Tween 20), PEG-6 lauramide (PEG refers to polyethylene glycol), alkyl polyglycosides (APG), such as alkyl polyglucosides, fatty alcohol ethoxylates, alkylphenol ethyxolates, fatty acid ethyxolates, fatty amide ethyxolates, alkyl glycosides, such as alkyl glucosides, sugar based non-ionic polymers such as sorbitan alkanoates, sorbitan fatty acid esters (Span), and combinations thereof.
Said at least one anionic surfactant is selected from the following group: sodium dodecyl sulphate, alpha-olefin sulphonates, alkyl sulphates, alkylbenzene sulphonates, alkyl ethersulphates, taurates, isethionates, and combinations thereof.
Said at least one anionic surfactant comprises or consists of sodium dodecyl sulphate.
Said at least one non-ionic polymer comprises or consists of PVA.
The foamed fibrous composition for at least one fibrous surface layer of the product comprises at least 0.5 wt-%, for example at least 1 wt-%, such 1 to 50 wt-% of polyvinyl alcohol, calculated from the weight of dry fibres in said fibrous composition.
The foamed fibrous composition for at least one inner fibrous layer of the product comprises at least 0.5 wt-%, for example at least 1 wt-%, such 1 to 50 wt-% of polyvinyl alcohol, calculated from the weight of dry fibres in said fibrous composition.
The foamed fibrous composition comprises non-ionic polymers and anionic surfactants at a molar ratio of 5:95 to 50:50, for example 10:90 to 30:70.
At least two, for example at least three of the foamed fibrous compositions further comprises a hydrophobic agent or a sizing agent.
At least one of the foamed fibrous compositions does not comprise any hydrophobic agent or a sizing agent.
The hydrophobic agent is included at least in the fibrous layer that is formed last.
The hydrophobic agent is included at least in the top fibrous layer.
The hydrophobic agent is included at least in an inner fibrous layer.
All inner fibrous layers of the product comprise a hydrophobic agent, preferably to impart barrier properties to the product, such as water resistance.
All fibrous layers of the product comprise a hydrophobic agent, preferably to impart barrier properties to the product, such as water resistance.
Said hydrophobic agent is alkyl ketene dimer (AKD).
The foamed fibrous composition for at least one fibrous layer comprises at least 0.1 wt-%, such as 0.1 to 1 wt-%, for example 0.2 to 0.8 wt-% of a hydrophobic agent, preferably AKD, calculated from the weight of dry fibres in said fibrous composition.
The moulded fibrous product comprises at least two fibrous layers, such as 2 to 5 layers, for example exactly three fibrous layers.
Each fibrous layer is formed by foam forming from a respective foamed fibrous composition, and preferably each composition, independently from each other, comprises one or more foaming agents.
The foamed fibrous compositions for the top and bottom fibrous layers comprises 1 to 50 wt-% of a non-ionic polymer as a foaming agent, calculated from the weight of dry fibres in said fibrous composition.
The foamed fibrous composition for the middle fibrous layer or an inner fibrous layer comprises 0.1 to 5 wt-% of at least one anionic surfactant, calculated from the weight of dry fibres in said fibrous composition.
The foamed fibrous composition for at least one fibrous layer comprises a surface-active foaming agent, a hydrophobic agent and a wet strength agent.
The foamed fibrous composition for at least one fibrous layer comprises SDS, AKD and PAE.
The foamed fibrous composition for at least one fibrous layer comprises SDS and AKD.
The foamed fibrous composition for at least one fibrous layer comprises PVA and AKD.
The cellulosic fibres of the top and the bottom fibrous layers have been refined, preferably to a Schopper-Riegler value of at least 20, such as at least 40, such as at least 50.
The cellulosic fibres of the top fibrous layer have been refined to a Schopper-Riegler value of at least 40, such as at least 50.
The cellulosic fibres of the bottom fibrous layer have been refined to a Schopper-Riegler value of at least 20, for example 20 to 40.
The obtained moulded fibrous product is further coated or is configured to be coated by a non-fibrous barrier coating layer which imparts water resistance, water vapour resistance, gas resistance, such as oxygen resistance, and/or oil and grease resistance.
The cellulosic fibres comprise bleached or unbleached chemical pulp and/or bleached or unbleached chemithermomechanical pulp.
Each fibrous layer is formed of a respective foamed fibrous composition, preferably of foamed fibrous compositions that have different compositions, by a foam forming method in a mould.
Each foamed fibrous composition comprises, independently from each other, cellulosic fibres, water, air and at least one foaming agent.
The foamed fibrous composition for at least one fibrous layer, such as an inner fibrous layer, comprises a surface-active foaming agent.
The foamed fibrous composition for at least one fibrous layer, such as a fibrous surface layer, comprises a polymeric foaming agent.
The foamed fibrous composition for a fibrous layer, such as a fibrous surface layer, comprises both a surface-active foaming agent and a polymeric foaming agent.
At least two of the foamed fibrous compositions comprise different foaming agent selections or different sets of foaming agents.
The total amount of foaming agents in each foamed fibrous composition is in the range 0.1 to 50 wt-%, for example 0.1 to 20 wt-%, for example 5 to 20 wt-% or for example 1 to 3 wt-% or for example 0.1 to 1 wt-%, calculated from the mass of dry fibres in said foamed fibrous composition.
Said at least two foaming agents consist of two foaming agents.
Said at least two foaming agents consist of or comprise three foaming agents.
Said at least two foaming agents comprise PVA and sodium dodecyl sulphate.
Said at least two foaming agents comprise polyethylene glycol dodecyl ether (Brij) and sodium dodecyl sulphate.
Said at least two foaming agents comprise an anionic surfactant and two non-ionic surfactants.
The foamed fibrous compositions for at least the surface fibrous layers, preferably for all fibrous layers, each comprise an anionic surfactant and two non-ionic surfactants.
Said at least two foaming agents comprise polyethylene glycol dodecyl ether (Brij), sodium dodecyl sulphate and PVA.
The foamed fibrous composition for at least one fibrous layer of the product comprises at least 10 wt-% of polyvinyl alcohol, calculated from the mass of dry fibres in said fibrous composition.
The foamed fibrous composition for at least one fibrous layer comprises non-ionic polymers and anionic surfactants at a molar ratio of 5:95 to 50:50, for example 10:90 to 30:70.
The foamed fibrous composition for at least one fibrous layer comprises polyethylene glycol dodecyl ether and sodium dodecyl sulphate at a molar ratio of 5:95 to 50:50, for example 10:90 to 30:70.
At least one of the foamed fibrous compositions, preferably for a top fibrous layer, further comprises a hydrophobic agent or a sizing agent, such as AKD.
The hydrophobic agent is included at least in the layer that is formed last.
The foamed fibrous composition for at least one fibrous layer comprises at least 0.1 wt-%, such as 0.1 to 1 wt-%, for example 0.2 to 0.8 wt-% of a hydrophobic agent, preferably AKD, calculated from the mass of dry fibres in said fibrous composition.
The moulded fibrous product comprises at least three fibrous layers.
Either or both of the foamed fibrous compositions for the top and bottom fibrous layers comprises 1 to 50 wt-% of a non-ionic polymer as a foaming agent, calculated from the weight of dry fibres in said fibrous composition.
The foamed fibrous composition for an inner fibrous layer comprises 0.1 to 5 wt-% of an anionic surfactant, calculated from the mass of dry fibres in said fibrous composition.
Either or both of the foamed fibrous compositions for the top and bottom fibrous layers comprises 0.1 to 5 wt-% of an anionic surfactant, calculated from the weight of dry fibres in said fibrous composition.
The foamed fibrous composition for an inner fibrous layer comprises 1 to 50 wt-% of a non-ionic polymer as a foaming agent, calculated from the mass of dry fibres in said fibrous composition.
The cellulosic fibres consist of or comprise wood pulp.
The hot-pressing comprises two hot-pressing steps, preferably by impulse drying.
The total duration of the hot-pressing (all hot-pressing steps in combination) is less than 2 minutes, such as less than 1 minute.
The foamed fibrous composition for at least one fibrous layer comprises 0.1 to 1 wt-%, for example 0.2 to 0.8 wt-% of AKD, calculated from the weight of dry fibres in said fibrous composition.
The moulded fibrous product comprises at least three fibrous layers, and the foamed fibrous composition for at least one fibrous layer comprises SDS as a surface-active foaming agent, AKD as a hydrophobic agent and PAE as a wet strength agent.
The moulded fibrous product comprises at least three fibrous layers, and the foamed fibrous compositions for the top and the bottom fibrous layers comprise a non-ionic polymer as a foaming agent, and the foamed fibrous composition for an inner fibrous layer comprises an anionic surfactant as a foaming agent, and the foamed fibrous composition for the top fibrous layer further comprises a hydrophobic agent, such as a size, and/or the foamed fibrous composition for the bottom fibrous layer further comprises a hydrophobic agent, such as a size.
The moulded fibrous product comprises at least three fibrous layers, and the foamed fibrous compositions for the top and the bottom fibrous layers comprise an anionic surfactant as a foaming agent, and the foamed fibrous composition for an inner fibrous layer comprises a non-ionic polymer as a foaming agent, and the foamed fibrous composition for the inner fibrous layer further comprises a hydrophobic agent, such as a size.
The foamed fibrous composition for at least one fibrous layer comprises a non-ionic surfactant, such as a glucamide, optionally in combination with an anionic surfactant, such as SDS.
At least two of the foamed fibrous compositions, independently from each other, comprise a non-ionic surfactant, optionally in combination with an anionic surfactant.

Various embodiments of the second aspect or the sixth aspect may comprise one or more features from the following bulleted list:
The product comprises at least two fibrous layers, such as 2 to 5 layers.
The product is a three-dimensional moulded product.
The product comprises curved surfaces or non-planar surfaces.
Each fibrous layer has a dry grammage in the range 30 to 700 g/m².
The Schopper-Riegler number of the cellulosic fibres of one or more inner fibrous layers of the product is less than 50, such as less than 30.
The Schopper-Riegler number of the cellulosic fibres of the top and/or bottom fibrous layers of the product is at least 20, such as at least 40, such as at least 50.
The Schopper-Riegler number of the cellulosic fibres of the bottom fibrous layer of the product is at least 20, such 20 to 40.
The Schopper-Riegler number of the cellulosic fibres of the top fibrous layer of the product is at least 40, such as at least 50.
The product is a food or liquid packaging or a food or liquid serving product or a part thereof, and preferably at least the top fibrous layer configured to be in contact with the food or liquid comprises a hydrophobic agent to impart barrier properties.
The product is a thin-walled moulded fibrous product obtained by a foam forming method, preferably having a variable or substantially constant thickness less than 2 mm.
The surfaces of the product that are configured to be in contact with food or liquid exhibit water-resistance and/or oil and grease resistance.
The surfaces of the product that are configured to be in contact with food or liquid are coated or are configured to be coated by a non-fibrous barrier coating layer.
Said non-fibrous barrier coating layer provides or enhances water-resistance, water vapour resistance, gas resistance, such as oxygen resistance, and/or oil and grease resistance of said surfaces.
The product has a thickness in the range 300 to 1000 μm, such as 300 to 700 μm, such as 450 to 900 μm.
The product has a Bendtsen smoothness in the range of 50 to 4000 ml/min, such as 100 to 1000 ml/min.
The product has a tensile index in the range of 25 to 60 Nm/g in the machine and cross directions.
The product has a modulus of elasticity in the range of 3.0 to 6.5 GPA in the machine and cross directions.
The product has a bending stiffness (Taber 15°) in the range of 40 to 80 mNm in the machine and cross directions.
The product is heat-sealed with a thermoplastic material or heat-sealable with a thermoplastic material, such as a thermoplastic packaging material.
The Schopper-Riegler number of the cellulosic fibres of one or more inner fibrous layers of the product is less than 30, and the Schopper-Riegler number of the cellulosic fibres of the bottom fibrous layer of the product is 20 to 40, and the Schopper-Riegler number of the cellulosic fibres of the top fibrous layer of the product is at least 40.

### Advantages of the Invention

The present invention may provide an improved method for internal sizing of a moulded fibrous product, particularly a multi-layer foam-formed moulded fibrous product.

In particularly, the present invention may be advantageous in the case of moulded fibrous products that are intended to be coated, for example by a water-based barrier coating. Such coated products include for example barrier-coated food packages. Some embodiments provide an effective method for sufficient internal sizing of such products.

Some embodiments may enable optimization of the location of sizing chemicals within a multi-layered moulded fibrous product.

In case of moulded fibre product surface modification, e.g. dispersion barrier coating, wettability of the moulded fibre surface may be critical, whereas too hydrophobic structure due to internal sizing may prevent coating film formation.

Some embodiments may enable improved heat-sealability with thermoplastic materials.

In some embodiments, optimizing foaming, sizing and additional chemicals individually in each foam layer, for example by using higher loadings of sizing and additive chemicals in inner layers, such as the middle layer, may enable combining internal and external barrier, thus providing high functionality in the moulded fibre product.

In some embodiments, properties of the moulded end product may be tailored and controlled better, because each layer may host a different set of foaming and hydrophobic agents in combination with cellulosic fibres. Particularly, hydrophobicity and related barrier effects may be constrained to desired parts/layers of the product while also the choice of surfactants in each layer may be varied to be compatible with the presence or absence of hydrophobic agent in that layer. Thus, the present invention may provide better control and tailoring of properties, particularly barrier properties, of a foam-formed article while retaining good foamability of the furnish.

The present invention may avoid the need for a separate non-fibrous barrier coating layer. Problems related to coating adhesion may be avoided.

The present invention may avoid use of separate plastic barrier coatings.

The present invention may enable fast preparation of multi-layered moulded fibrous products. The cycle times may be shorter. The wetting or rewetting of the product due to separate coating steps may be avoided.

The present invention may enable facile tailoring of the properties of the individual layers.

In the present products, the distribution of the cellulosic fibres may be more even.

In the present invention, fibre flocculation and cloudy appearance may be avoided or reduced.

The present invention may provide biodegradable, compostable and recyclable multi-layered moulded fibrous products that are suitable for food contact, such as ovenable and/or micro-ovenable products.

The present invention may reduce energy consumption due to reduced need of dewatering and drying of the product, particularly when using foam forming.

The present invention may reduce production costs related to cycle time, dewatering, drying, and chemicals. Chemical retention may be enhanced particularly when using foam forming.

The present invention may provide fibrous products with good internal barrier properties.

The present invention may provide fibrous products in complex geometries without creases and cracks.

The present invention may be advantageous with regard to production of demanding geometries, such as variable-thickness walls or thin walls, deep drawing walls, rimming structures and low-friction surfaces.

The present invention may provide plastic-free fibre packages that are recyclable in existing fibre recycling infrastructures.

The present invention may provide biodegradable and/or compostable products.

The present invention may enable replacing existing, often plastic-based, packaging solutions.

### BRIEF DESCRIPTION OF THE DRAWINGS

FIG. 1 schematically illustrates a multi-layered fibrous product in accordance with at least some embodiments of the present invention;

FIGS. 2 to 4 show stereomicroscope images of fibrous structures;

FIG. 5 shows a flow chart illustrating process steps for manufacturing a multi-layered foam-formed product in accordance with at least some embodiments of the present invention; and

FIG. 6 illustrates foam forming of a three-layered fibrous structure in accordance with at least some embodiments of the present invention.

### EMBODIMENTS

### Definitions

Unless otherwise stated herein or clear from the context, any percentages referred to herein are expressed as percent by weight based on a total dry weight of the respective composition.

The amounts of additives are usually expressed as percent by weight, calculated from the weight of dry fibres in the respective composition.

In the present context, the term “hot pressing” typically refers to a method of applying increased pressure and increased temperature for a period of time. Hot pressing may involve several successive cycles or steps of applying increased pressure and temperature. In some instances, hot pressing may involve application of sub-atmospheric pressure. Typically, an aim of a hot pressing step is to obtain a strong and dimensionally stable product with smooth product surfaces.

In the present context, the term “moulded product” refers to a product obtained by shaping a product or giving a product a shape inside a closed or closable cavity of a mould. Typically, “moulding” does not refer to mere pressing of a product between two plates.

In the present context, the term “cellulosic fibrous material” may refer to a material comprising cellulosic and/or lignocellulosic fibres.

Typically, the term “top fibrous layer” or “the uppermost fibrous layer” refers to the fibrous surface layer that is to be located nearest to or in contact with the content of the package, such as food.

Typically, the term “bottom fibrous layer” or “the lowermost fibrous layer” refers to the fibrous surface layer that is located on the opposite side of the fibrous structure with regard to the top fibrous layer.

Typically, the term “surface-active foaming agent” refers to a surfactant.

The present products are typically three-dimensional moulded single- or multi-layered fibrous products obtained by using a foam-forming process.

We have observed that particular combinations of additives are advantageous when preparing moulded fibrous products by foam forming. The additives are typically added to a fibrous slush, for example before or after foaming the fibrous slush or before or after adding a foamed composition to the fibrous slush. In yet another embodiment, additives are added to the structure after the foam forming step but before the hot-pressing step.

Particularly, we have observed that successful internal sizing, typically by a hydrophobic size, of a foam-formed moulded fibrous product may be achieved by using particular combinations of foaming agents, such as surfactants, and additives, such as retention aids, fixing agents and wet strength agents, in addition to said size.

Further, we have observed that advantages can be achieved via use of several foaming chemicals in the manufacturing of a foam-formed multi-layered fibrous product. Each layer of such as product may be manufactured with an optimized combination of foaming chemicals and optionally further additives.

At least one of the layers of the product is a fibrous layer comprising a cellulosic fibrous material.

### Cellulosic Fibrous Material

The cellulosic fibrous material may comprise wood pulp, such as hardwood pulp and/or softwood pulp.

The softwood pulp may be made from spruce or pine or mixtures thereof.

The hardwood pulp may be made from birch, poplar, aspen, alder, maple, eucalyptus tropical hardwood, or mixtures thereof.

The wood pulp may be a mixture of hardwood and softwood pulp.

In one embodiment, the cellulosic fibrous material may comprise pulp made from any annual such as straw, common reed, reed canary grass, bamboo, sugarcane, bagasse or any grass plant.

In an embodiment, the cellulosic fibrous material comprises hardwood pulp and softwood pulp at a weight ratio in the range 1:2 to 2:1.

The cellulosic fibrous material may comprise wood pulp selected from the following group: chemical pulp, mechanical pulp, and any combinations thereof.

The cellulosic fibrous material may comprise one or more of the following: chemical wood pulp, mechanical wood pulp, such as chemithermomechanical wood pulp, fibrillated cellulose, such as microfibrillated cellulose (MFC), nanocellulose, and any other cellulosic material comprising cellulosic fibres or parts of cellulosic fibres.

MFC and nanocellulose may be from wood or non-wood sources.

Advantageously, at least one of the fibrous layers, for example an inner layer, comprises bleached chemithermomechanical wood pulp (BCTMP). The BCTMP may be refined to a Canadian Standard Freeness of less than 800 ml, such as 600 to 800 ml. The BCTMP may also be unrefined.

The cellulosic fibrous material may also comprise non-wood pulp, such as straw pulp.

In some embodiments, the cellulosic fibrous material comprises or substantially consists of virgin wood pulp, such as virgin bleached chemical pulp that is substantially free from lignin, which makes the product particularly suitable for food contact, for example for cooking, heating, ovening and micro-ovening.

In an embodiment, at least 80 wt-%, such as at least 95 wt-% of the cellulosic fibrous material of the product consists of virgin cellulosic fibres, such as virgin wood pulp.

An advantage of virgin pulp is that it is free from pigments and other undesired chemicals. Recycled waste materials often contain chemical and microbiological contaminants, which may affect their safe use. Mixtures of chemical compounds and microbial products may leach out from recycled materials and cause a variety of negative health or environmental impacts. Not only the harmfulness of individual chemical compounds, but also their interactions with other chemical compounds and microbial products may increase the toxicity of recycled materials and their emissions. Therefore, the present invention preferably avoids use of recycled materials.

In some embodiments, recycled materials may be used.

An advantage of chemical pulp, such as bleached chemical pulp, is that it is substantially free from lignin. A further advantage of chemical pulp is that inter-fibre bonding in the end product may be better than in the case of mechanical pulp.

Lignin-containing pulps often have an insufficient organoleptic quality for direct food contact. In addition, lignin-containing pulps are sensitive for ageing and yellowing of the material.

### Foam Forming

Advantageously, one or more of the fibrous layers of the product are obtained by a foam forming method.

The multi-layered product is preferably obtained so that all fibres to be included in the end structure undergo a foam forming process. In some embodiments, all fibres to be included in layers exhibiting barrier properties undergo a foam-forming process.

For example, at least the fibrous layer exhibiting barrier properties has been obtained by a foam forming method in a mould. Such a fibrous barrier layer may be any of the fibrous layers, such as the uppermost fibrous layer, the lowermost fibrous layer and/or one or more of the inner fibrous layers.

The advantage of foam forming is that lighter and bulkier products may be prepared. Additionally, a more homogeneous formation may be achieved. Use of foam enables facile preparation of multi-layered structures in a modular process, i.e. all layers may be formed in the same mould but still with an individually tailored composition and selection of fibrous raw materials and additives in each layer to form a multi-layered shape or structure in the mould, which structure is then hot-pressed.

An advantage of dewatering the entire multilayer structure in the same mould is that inter-layer bonding may be enhanced also during the dewatering in comparison to dewatering the layers individually.

In some embodiments, in addition to foam-formed layers, the end product may further comprise water-formed layers. Such water-formed layer or layers may be formed in a separate process and combined with the foam-formed layer or the foam-formed multi-layered structure by hot-pressing. An advantage of water forming is that foaming chemicals are absent and therefore not interfering with the functioning of sizes. In water-forming methods, the individual layers are typically formed and removed from the mould independently from each other. Separate moulds may be used. After being removed from the mould(s), the layers may be piled to a stack and joined to each other and/or to other layers by hot-pressing.

In some embodiments, in addition to foam-formed layers, the end product may further comprise water-formed layers, and all layers, i.e. the water-formed layer or layers and the foam-formed layer or layers, are formed in the same mould, to form a multi-layered shape or structure in the mould, which structure is then hot-pressed.

In one embodiment, the product comprises several fibrous layers that are prepared by water-forming processes and combined to each other and optionally additionally to at least one foam-formed fibrous layer. Advantageously, the foam-formed layer or layers constitute one or more of the inner fibrous layers, such as the middle layer of the product and advantageously exhibit the barrier properties.

In an embodiment, the product may comprise one or more water-formed layers and one or more foam-formed layers. In an embodiment, an inner fibrous layer or inner fibrous layers have been water-formed, and the top and bottom fibrous layers have been foam-formed.

An advantage of the multi-layered products according to some embodiments is that migration of substances may occur during forming and/or hot-pressing. For example, additive dosing, such as size dosing, may be focused on or increased in layers that are prepared and formed last, such as the top fibrous layer. During dewatering and/or hot-pressing, for example the pressure and/or temperature gradient may direct migration of substances within the multilayer structure to a desired direction.

One embodiment provides a product obtained by a following method.

In some embodiments, the product or at least one of its fibrous layers may be obtained by a method comprising the following steps: providing a fibrous slush comprising fibres; refining the fibres of the fibrous slush and/or adding additives, such as barrier agents, to the fibrous slush; turning the fibrous slush to a foamed composition; forming, such as shaping and pressing, the foamed composition in a mould; dewatering; and hot-pressing.

In some embodiments, a barrier agent, or any other additive, may alternatively or additionally be added in a later stage of the method, for example by applying a composition comprising a barrier agent to a fibrous foam or to an already-formed fibrous layer, preferably a foam-formed layer.

In the method, a foamed composition comprising fibres, water, air and one or more foaming agents is first provided. The foam may further comprise fillers, additives, retention aids, fixatives, pigments, binders, strength agents, barrier dispersions and/or sizing agents. The foamed composition in then formed in a mould.

In an embodiment, the method comprises: in a mould, forming a multi-layered foamed fibrous structure from foamed fibrous compositions, wherein each of the foamed fibrous compositions comprises cellulosic fibres, water, air, and at least one foaming agent; dewatering the foamed fibrous structure; hot-pressing the dewatered structure, to obtain a moulded fibrous product. Said at least one foaming agent comprises at least one surface-active foaming agent, such as an anionic surfactant, and/or at least one polymeric foaming agent, such as a non-ionic polymer. Preferably at least one of the foamed fibrous compositions comprises a hydrophobic agent.

In another embodiment, the method comprises: in a mould, forming a multi-layered foamed fibrous structure from foamed fibrous compositions, wherein each of the foamed fibrous compositions comprises cellulosic fibres, water, air and a foaming agent; dewatering the foamed fibrous structure; hot-pressing the dewatered structure, to obtain a moulded multi-layered fibrous product, in which method at least two different foaming agents are applied. Said at least two different foaming agents are selected, independently from each other, from the group of surface-active foaming agents and polymeric foaming agents.

Typically, a different type of foamed fibrous composition is used for preparing each layer of a multi-layered product. Each foamed composition may comprise a dedicated set of foaming agents and other additives, such as hydrophobic agents. By “different type” it is referred to having a different composition, such as different foaming agent and additive selections and/or different concentrations.

The foaming agent preferably comprises a surface-active foaming agent, such as a surfactant, and/or a non-ionic polymeric foaming agent or a mixture thereof.

A surfactant is typically a molecule with two parts: a polar or hydrophilic head group and a hydrophobic tail.

A gemini surfactant has two polar head groups connected with a spacer and can be anionic, non-ionic, cationic, or zwitterionic.

In an embodiment, the surfactant comprises a gemini surfactant.

In an embodiment, the surfactant is cleavable, for example in particular pH values or enzymatically. The foaming properties of such cleavable surfactants may be eliminated by cleavage later in the production process, if necessary, such as in water circulation.

In an embodiment, the surfactant has been synthesized at least partly, preferably entirely from renewable raw materials. The surfactant may be at least partially bio-based, such as 100% (entirely) bio-based.

The surfactant may comprise a zwitterionic surfactant selected from the following group: betaine, amidobetaine, imidazoline, amide oxide, and combinations thereof. An advantage of these surfactants is that they are broadly compatible with other classes of surfactants and are generally stable in varying pH.

One or more foaming agents may be used in each of the fibrous layers independently from each other.

The surfactant may be non-ionic, anionic, cationic or amphoteric.

The surfactant for foam forming may have an anionic, non-ionic, cationic, or zwitterionic polar headgroup.

The surfactant may have a hydrocarbon tail which may be straight-chain, branched-chain, or a double-tail chain.

For foam forming, hydrophilic surfactants with straight or double-chain tails are preferred.

In an embodiment, at least one anionic surfactant is used.

In an embodiment, at least one non-ionic polymer is used.

In an embodiment, at least one anionic surfactant and at least one non-ionic polymer are used as foaming agents, particularly for improving foaming. For example, the anionic surfactant may be sodium dodecyl sulphate (SDS), and the non-ionic polymer may be polyoxyethylene (23) lauryl ether or polyoxyethylene sorbitan fatty acid ester and sorbitan ester.

In an embodiment, at least one hydrophilic surfactant and at least one lipophilic or hydrophobic foaming agent are used as foaming agents. For example, the hydrophilic surfactant may be Tween, which is a non-ionic hydrophilic surfactant, and the lipophilic foaming agent may be a sorbitan based foaming agent.

A suitable amount of an anionic surfactant is 0.2 to 5 g/L (grams per one litre of fibrous stock).

A suitable amount of an anionic surfactant is 1 to 20 wt-% per dry fibre.

The anionic surfactant may be selected from the following group: sodium dodecyl sulphate (SDS), alpha-olefin sulphonates, alkyl sulphates, alkylbenzene sulphonates, alkyl ethersulphates, taurates, isethionates, and combinations thereof.

Examples of non-ionic foaming chemicals include non-ionic polymeric foaming chemicals, such as polyvinyl alcohol.

The non-ionic polymer may be selected from the following group: polyvinyl alcohol (PVA), polyethylene glycol dodecyl ether (Brij), polyethylene glycol sorbitan monolaurate (Tween 20), PEG-6 lauramide, alkyl polyglycosides (APG), such as alkyl polyglucosides, fatty alcohol ethoxylates, alkylphenol ethyxolates, fatty acid ethyxolates, fatty amide ethyxolates, alkyl glycosides, such as alkyl glucosides, sugar based non-ionic polymers such as sorbitan alkanoates, and combinations thereof.

In some embodiments, said at least one foaming agent may be selected from anionic surfactants and non-ionic surfactants.

In an embodiment, the foamed fibrous composition for at least one fibrous layer comprises an anionic surfactant, such as SDS, and a non-ionic surfactant, such as a glucamide.

In an embodiment, the foamed fibrous composition for at least one fibrous layer comprises SDS and a glucamide.

In an embodiment, the foamed fibrous composition for at least one fibrous layer comprises SDS and an alkyl polyglycoside (APG).

In some embodiments, said at least one foaming agent may be selected from the following group: SDS, alkyl polyglycosides (APG), glycinates, glucamides and any combinations thereof.

Foaming agents such as surfactants, and additives more generally, may be arranged to recirculate in the present method.

Typically, the bubble size (diameter) in the foam is approximately 10 to 300 μm, for example 50 to 250 μm, usually approximately 100 to 150 μm.

In one embodiment, a composition suitable for foaming is obtained by mixing fibre slush (fibre stock), which has a consistency of approximately 0.5 to 7% by weight (the amount of fibre in relation to slush weight), with a foam which is formed from water and a foaming agent and the air content of which is approximately 10 to 90% by volume, for example 20 to 80%, such as 50 to 70% by volume, in which case a foamed fibre slush is generated having a fibre content of approximately 0.1 to 3% by weight.

In one embodiment, instead of mixing the fibre slush with a pre-generated foam, a foaming agent may be added to the fibre slush, and the mixture is thereafter foamed to obtain a foamed fibre slush. The mixture to be foamed typically has a consistency in the range 0.5 to 3%, such as 1.0 to 2.5%.

For example, a fibrous slush with a consistency of 0.5 to 7%, such as 1 to 3%, is first provided. Optionally, the pH of the fibrous slush is adjusted to above 7, such as 7 to 9. Thereafter, at least one foaming agent and optionally additives, such as wet strength agents, are added to the fibrous slush. For example, a wet strength agent, such as PAE, may be added first, and a foaming agent, such as a surfactant, thereafter. The fibrous slush is then foamed, after which further additives, typically hydrophobic agents and/or wet strength agents, may be added to the foamed mixture.

The fibres may include all types of fibres from chemical and/or mechanical pulping, recycled fibres, broke fibres, agricultural waste streams, annual plant fibres, by-products, micro- or nano-fibrillated cellulose fibres of wood origin or non-wood origin, and regenerated cellulose fibres, and combinations thereof.

In one embodiment, a moulded multi-layered fibrous product is obtained by a method comprising: forming a moulded multi-layered foamed structure from at least one foamed fibrous composition comprising cellulosic fibres, water, air and a foaming agent and optionally also barrier agents and additives; dewatering the structure, preferably by applying a vacuum; and hot-pressing the dewatered structure to obtain the moulded multi-layered fibrous product. At least one of the fibrous layers of the multi-layered fibrous product may exhibit barrier properties substantially throughout its structure.

In the present context, “forming”, typically foam forming, refers to the process of giving the foamed composition a shape, such as a three-dimensional shape, in a mould.

In the preferred method, a foamed fibrous composition is fed to a mould, typically to a cavity in a mould. The mould typically comprises a cavity or an inner space defined by mould inner surfaces. In the cavity the fed foamed composition is shaped. The cavity may have a dimension, such as the shortest dimension, in the range 0.1 to 100 mm, such as 3 to 100 mm, such as 5 to 60 mm, in the closed configuration of the mould.

Said shortest dimension or smallest dimension typically refers to the thickness of the product or layer to be moulded.

The foamed composition may be fed to the mould to provide an amount of the foamed composition, such as a layer of the foamed composition, onto at least one inner surface of the mould. The layer is typically non-planar and may be understood as a thickness, such as a variable thickness or a substantially constant thickness, of the foamed composition lying on the inner surface of the mould and conforming to the shape of said surface.

Typically, the shaping step comprises pressing said fibrous composition in the inner space of the mould by making parts of the mould to approach each other.

The step of forming a multi-layered foamed structure may comprise feeding a first fibrous composition in a foamed form into the mould, and shaping said first fibrous composition in the mould, to prepare a first foamed fibrous layer. Thereafter, without removing the first fibrous layer from the mould, the process is continued by feeding a second fibrous composition in a foamed form into the mould, and shaping said second fibrous composition in the mould, to prepare a second foamed fibrous layer. As a result, a two-layered moulded foamed structure is obtained in the mould. The process may be continued to add further fibrous layers to the moulded foamed structure.

The first fibrous composition and the second fibrous composition may differ from each other for example with regard to the foaming agents and additives such as barrier agents or hydrophobic agents, or with regard to the cellulosic fibres.

If not otherwise stated, by “parts of the mould” it is referred to such parts of the mould that serve to define the inner space and thus contribute to shaping the foamed fibrous composition.

The second foamed fibrous layer may be fed and thus become located either on top of or alternatively under the first foamed fibrous layer in the mould. Also, said feeding steps may be carried out in either order: either the first layer or the second layer may be formed first into the mould.

For example, when preparing a multi-layered moulded foamed structure, the layers may be formed in any suitable order. An inner (to-be) fibrous layer may be formed first, and the top and bottom fibrous layers thereafter on both sides of the inner fibrous layer. Alternatively, the top (to-be) fibrous layer or the bottom (to-be) fibrous layer may be formed first, and the other fibrous layers thereafter.

It may also be envisaged that the product is obtained by using separate moulds for preparing said first and second foamed fibrous layers, and the obtained first and second fibrous layers are joined in said hot-pressing step.

In one embodiment, said feeding into the mould comprises feeding the foamed fibrous composition in a foamed form into an inner space or inner volume of the mould, wherein said inner space is limited by inner surfaces of the mould.

Application of vacuum in the dewatering step is preferably enabled.

The final multi-layered foamed structure is removed from the mould by opening the mould.

Adjusting the distance between the parts of the mould during feeding and shaping of the foamed compositions is preferably enabled.

Before starting to feed a further, such as a second fibrous composition into the mould, it is typically necessary to enlarge the inner space of the mould by moving the parts of the mould farther from each other. The volume of the inner space may be diminished or enlarged to shape the already-fed foam and, respectively, to make room for the foam to be fed next.

In all adjustments of the volume of the inner space of the mould, some parts of the mould may remain stationary while other parts are moved.

In one example, one or more parts of the mould remain stationary and one or more other parts of the mould move during said approaching or during said enlarging.

For example, the mould may comprise two submoulds, such as two halves, that are arranged to face each other and to be movable with regard to each other. The submoulds may be approached towards each other to shape the product. The submoulds may be moved apart from each other to enlarge the inner space or even farther to open the mould and to remove the shaped product from the mould.

In one example, the product is obtainable by using a mould comprising two parts: a negative mould and a positive mould, which may be arranged to face each other to encase an inner space, also referred to as a moulding space or moulding cavity, between the two parts. The composition to be moulded or shaped is fed into the moulding space and the negative mould and/or the positive mould are approached toward each other to give the composition the shape corresponding to the shape of the moulding space. By ‘approaching’, it is referred to a process in which the inner space is diminished by means of moving one or both of the positive and negative moulds.

Dewatering of the structure may be carried out by applying vacuum to the inner space of the mould containing the fed foamed composition(s).

The dewatering step precedes the hot-pressing step, which hot-pressing leads to the final, typically smooth and dry product in which all layers have been joined to each other.

In the hot-pressing, the temperature is typically higher than room temperature, for example at least 50° C., such as at least 100° C., for example in the range at least 150 to 240° C.

In the hot-pressing, a sub-atmospheric pressure may be applied, for example a pressure of 600 kPa or less.

The hot-pressing may comprise two or more successive steps of hot-pressing. Said hot-pressing may have a total duration of less than 60 seconds, such as less than 30 seconds.

During hot-pressing, heat may be applied from one or both sides of the material to be pressed. In an embodiment, heat is applied only from one side.

For example, the hot-pressing may involve two hot-pressing steps in both of which heat is applied from the same side. Alternatively, the hot-pressing may involve two hot-pressing steps in which heat is applied from different sides.

Hot pressing may contribute to development of the barrier or other functional properties, for example via chemical reactions taking place in elevated temperature, such as cross-linking and curing reactions. Therefore, hot pressing may be advantageous when using additive chemicals the action of which becomes enhanced by cross-linking or curing.

Hot pressing may also contribute to the flow of additives such as barrier agents or hydrophobic agents within the multi-layered fibrous structure.

Hot pressing may contribute to the flow of barrier chemicals. For example, hot pressing from one side may direct flow of a barrier chemical within the layers in a different way when compared to hot pressing symmetrically from both sides.

Hot pressing preferably comprises impulse drying.

Impulse drying typically comprises wet-pressing with the application of heat. The applied heat may have two roles: It may reduce the viscous resistance of the water and it may soften the structure of the pulp, so that it becomes more compressible, resulting in a smooth surface. If the heat transfer rate is sufficiently high, a vapor phase may be generated on the wet side in contact with the high temperature medium. This may assist in the dewatering process as the expanding steam can displace the bound water.

### Additives, Barrier Properties and Sizing

At least one of the fibrous layers may comprise one or more of the following additives: pigments, such as talc, clay, and calcium carbonate; retention aids; fixatives; barrier agents; latex binders; water-soluble binders, starch, wet strength agents, CMC; sizes, such as AKD.

The amount of the additives may be in the range 0.01 to 30 wt-%, such as 0.01 to 10 wt-%, such as 0.1 to 8 wt-%, for example 1 to 5 wt-%, calculated from the weight of dry fibres in the fibrous layer. In each individual fibrous layer the amount and nature or function of additives may be selected individually from each other. Preferably via contribution of additives via their presence or absence in each fibrous layer individually, the properties of the entire product can be optimised.

Any of the fibrous layers of the product may be provided with barrier properties by refining the fibres and/or by adding barrier agents or hydrophobic agents or strengthening agents and/or by selecting suitable foaming agents. Different barrier properties may be provided to the fibrous layers. For example, one of the fibrous layers may exhibit oil and grease resistance while another fibrous layer may exhibit water-resistance.

An example of a barrier additive is a size or a hydrophobic agent, typically for internal sizing and/or for surface sizing, preferably for internal sizing. Preferably the size is a foamable size, such as a resin size. In an embodiment, the size is configured to not inhibit or reduce the foaming action of the foaming chemicals.

The barrier additives may be added to the fibrous furnish or slush before the foaming step, at a consistency of for example 0.5 to 15%, such as 2 to 10%, and/or before the foam forming step, to the foam or to be mixed with the fibrous slush with said consistency.

The barrier additives are preferably added to the fibrous furnish or slush at a consistency of less than 10%, such as less than 5%.

In an embodiment, at least one of the fibrous layers comprises a size.

In some embodiments, different amounts of a size may be dosed to the fibrous compositions for individual layers of a multilayer product. For example, at least before the hot-pressing, the fibrous composition for the bottom fibrous layer of the product may comprise less hydrophobic agent or size than the fibrous compositions for the other layers, particularly the top fibrous layer of the product. For example, the fibrous composition for the bottom fibrous layer may comprise 50 wt-% less size than the fibrous composition for the top fibrous layer. Preferably, during hot pressing or impulse drying, a part of the size dosed to the top fibrous layer will migrate to other fibrous layers.

The size may be a cationic size, an anionic size and/or a reactive size.

Suitable cationic sizes include cationic starches and starch derivatives as well as corresponding carbohydrate-based natural polymers. Of synthetic polymers, for example styrene/acrylate copolymers (SA), polyurethanes and alkylated urethanes may be used.

Suitable anionic sizes include anionic starches and starch derivatives and corresponding carbohydrate-based natural polymers such as carboxymethylcellulose and its salts, alkyl celluloses such as methyl cellulose and ethyl cellulose. Synthetic polymers include: styrene/maleic acid copolymer (SMA), diisobutylene/maleic anhydride, styrene acrylate copolymers, acrylonitrile/acrylate copolymers, and polyurethanes and similar latex products containing the same chemical functionalities.

Also non-ionic starches may be used.

In some embodiments, the size is a modified rosin, a wax, an oil, or a polymer.

An advantage of using a size is that undesired absorption of liquid and/or water and/or moisture into the foam formed structure may be reduced. Thus, moisture-resistance or water-resistance of the product is improved.

An example of a wax-type size is alkyl ketene dimer (AKD).

AKD may be a cationic AKD or an anionic AKD, preferably a cationic AKD.

AKD may be in the form of a dispersion, such as an aqueous dispersion of AKD and a polymer. The polymer may be a cationic modified starch.

An example of an oil is alkenyl succinic anhydride (ASA).

An example of a polymeric size is styrene acrylate emulsion (SAE).

A preferred size is AKD or a similar wax.

Examples of only slightly cationic sizes or non-ionic sizes include an AKD dispersion not containing cationic polymers, and resin adhesives, such as foamable resin adhesive. The advantage of such sizes is that they are less prone to inhibit or reduce and may even enhance foaming action of the foaming chemicals.

An example of a size is a mixture of resin adhesive and AKD.

For example, the size may be selected from the group AKD, ASA, rosin products, and polymer and co-polymer products.

In some embodiments, the size is AKD which has been stabilized or emulsified with cationic starch or other cationic polymer.

In some embodiments, the size is AKD which has not been stabilized or emulsified with any cationic starch or other cationic polymer.

In some embodiments, eventual disadvantageous effects of a size on foam stability and quality may be alleviated by selecting a suitable combination and location of foaming chemicals. Particularly it is advantageous to mutually optimize the charge states or charge environment of the size and the foaming chemicals.

For example, in case of a cationic size, it may be advantageous to use an anionic surfactant and/or a non-ionic polymer as a foaming agent.

As another example, in the case of a combination of a cationic size and a non-ionic size, it may be advantageous to use an anionic surfactant as a foaming chemical.

In some embodiments, at least one of the fibrous layers comprises a size, optionally in combination with one or more other additives. Preferably said fibrous layer also comprises PAE. PAE may be capable of enhancing binding of the size, particularly AKD, to the fibres.

Typically, the hydrophobic agent, such as a size, is added after the foaming step, to the foamed fibrous composition.

In an embodiment, the hydrophobic agent, such as a size, is added later in the process than other additives, such as the foaming agents and optionally a retention aid.

In a multilayer product, one or more of the layers may be free from anionic surfactants, whereas one or more of the other layers may comprise an anionic surfactant. Optionally, said layers free from anionic surfactants may comprise a size, such as a cationic size, and optionally also a non-ionic polymer.

For example, a fibrous surface layer of the product may comprise a non-ionic polymer.

For example, an inner layer of the product may be free from anionic surfactants. Said inner layer may comprise a size.

For example, a back layer of the product may comprise an anionic surfactant.

In one embodiment, at least one of the fibrous layers comprises talc, such as 0.1 to 5 wt-% talc.

In one embodiment, at least one of the fibrous layers comprises clay, such as 0.1 to 5 wt-% clay.

In one embodiment, at least one of the fibrous layers comprises calcium carbonate, such as 0.1 to 5 wt-% calcium carbonate.

In one embodiment, at least one of the fibrous layers comprises barrier agents selected from the following group: polyolefins, polyesters, other thermoplastic polymers, biodegradable polymers, such as polylactic acid, starch and its derivatives, plastomers, elastomers, ethylene vinyl alcohol, and any derivatives, co-polymers and mixtures thereof.

In one embodiment, at least one of the fibrous layers comprises 0.1 to 15 wt-%, such as 0.1 to 10 wt-%, such as 0.1 to 5 wt-% barrier agents, such as dispersion polymer barrier agents. Such barrier agents typically provide said barrier properties throughout the structure of the fibrous layer, particularly in the absence of any refining.

In one embodiment, at least one of the fibrous layers comprises 0.1 to 5 wt-% polymeric latex binders, such as styrene butadiene latex, styrene acrylate latex, polyvinyl acetate latex.

In one embodiment, at least one of the fibrous layers comprises 0.1 to 25 wt-%, such as 5 to 15 wt-% polyvinyl alcohol (PVA).

In one embodiment, at least one of the fibrous layers comprises 0.1 to 20 wt-%, such as 0.1 to 5 wt-% starch.

The starch may be native, modified, cooked or swelled cationic starch.

In one embodiment, at least one of the fibrous layers comprises 0.1 to 5 wt-% CMC.

In one embodiment, at least one of the fibrous layers comprises 0.1 to 5 wt-% polyamide-epichlorohydrin (PAE). Preferably said fibrous layer also comprises a size, such as AKD. PAE may be capable of enhancing binding of the size to the fibres.

In one embodiment, at least one of the fibrous layers comprises a retention aid, for example 0.1 to 5 wt-% of a retention aid.

The retention aid may be an anionic polymeric retention aid.

In one embodiment, at least one of the fibrous layers comprises a wet strength agent.

The wet strength agent may be selected from the group consisting of polyamide epichlorohydrin, polyethylene imine, dialdehyde starch, polyacryl amides, glyoxal or melamine formaldehyde, polyamidoamineepichlorohydrin and urea formaldehyde melamine and any combinations thereof.

In one embodiment, at least one of the fibrous layers comprises a dispersion agent or a flotation agent.

In one embodiment, at least one of the fibrous layers comprises mineral fillers, such as 0.1 to 20 wt-% mineral fillers.

In an embodiment, the fibrous layers of the product comprise less than 5 wt-%, such as less than 1 wt-% mineral fillers.

In one embodiment, all or at least one of the fibrous layers comprises 0.1 to 20 wt-% strengthening additives, such as nanocellulose or microfibrillated cellulose (MFC) or other strengthening cellulose-based material.

Preferably, the fibrous layers of the product comprise less than 10 wt-%, such as less than 5 wt-%, such as less than 2 wt-% of waxes, plastics and fluorochemicals. In one embodiment, the fibrous layers of the product comprise less than 2 wt-% of waxes. In one embodiment, the fibrous layers of the product comprise less than 2 wt-%, such as less than 1 wt-% of plastics. In one embodiment, the fibrous layers of the product comprise less than 2 wt-%, such as less than 1 wt-% of fluorochemicals. In some embodiments, the product is substantially free of waxes, plastics, such as thermoplastic materials, and fluorochemicals, particularly free of fluorochemicals.

For ovenable applications, the additives and the foaming chemicals may be selected among additives which are approved for use in food contact materials or packages and which additionally are approved for ovenable food packaging materials intended for heating. Preferably, the additives are selected among those approved in: BfR XXXVI/2. Paper and Paperboard for Baking Purposes: https://www.bfr.bund.de/cm/349/XXXVI-2-Paper-and-Paperboard-for-Baking-Purposes.pdf.

For products not intended for oven, the additives and the foaming chemicals may be selected more freely among all additives that are approved for use in food contact materials or packages.

The amount of the barrier additive may be in the range 0.5 to 25 wt-%, such as 1 to 10 wt-%, such as 2 to 10 wt-%, such as 5 to 8 wt-%, calculated from the weight of dry fibres in the fibrous layer.

By ‘food contact materials’ it is referred to all materials and articles intended to come into contact with food, such as packaging and containers.

Preferably, the present product complies with Regulation (EC) No 1935/2004.

In one embodiment, the additives, such as pigments, binders, and sizes are compliant with ovenable products.

### Product and Grammage

In some embodiments, the product has a dry grammage in the range of 5 to 900 g/m², for example in the range of 100 to 900 g/m², such as in the range of 200 to 750 g/m², such as 300 to 600 g/m².

In an embodiment, each of the fibrous layers may have a dry grammage in the range of 40 to 400 g/m², such as 80 to 300 g/m².

In one embodiment, the lowermost fibrous layer and/or the inner fibrous layers of the product has a dry grammage in the range of 80 to 400 g/m², such as 100 to 400 g/m², such as 200 to 300 g/m².

In one embodiment, the lowermost and the uppermost fibrous layers of the product each have a dry grammage in the range of 80 to 150 g/m².

In one embodiment, an inner fibrous layer or the middle fibrous layer of the product has a dry grammage in the range of 150 to 250 g/m².

In one embodiment, the first fibrous layer and/or the second fibrous layer of the product has a dry grammage in the range of 10 to 150 g/m², such as 60 to 150 g/m², or for example 20 to 60 g/m², such as 30 to 50 g/m².

In an embodiment, the average density of the product is larger than 500 kg/m³, such as larger than 600 kg/m³, such as larger than 700 kg/m³.

In an embodiment, the density of an inner fibrous layer or inner fibrous layers is larger than 100 kg/m³.

In some embodiments, the product may comprise 2 to 20 fibrous layers, such as at least three fibrous layers, for example exactly three fibrous layers.

In some embodiments, the product comprises exactly two fibrous layers or exactly three fibrous layers.

Preferably, the product is a three-dimensional moulded multi-layered fibrous product, obtained by using a mould comprising at least one three-dimensional, non-planar mould surface, wherein said product exhibits a three-dimensional shape conforming to the shape of said three-dimensional, non-planar mould surface.

For example, the product may have a shape of a cup, a plate, a bowl, a pan, a clam-shell or a tray.

Typically, the product is a food or liquid packaging or container or a food or liquid serving product, such as a cup for beverage or a food tray or plate or a baking pan or a disposable lasagne tray type product.

In some embodiments, the product is ovenable, such as ovenable to a temperature of at least 100° C., preferably to at least 220° C.

In some embodiments, the product is a micro-ovenable food or liquid packaging or container, such as a food tray.

In one example, the product is a container for baking, such as an ovenable pan.

The product may be used for packaging, storing, serving, preparing, cooking and/or heating of food or liquid. The liquid may be drinkable liquid, such as beverage.

More generally, the product may be used for packaging and storing any oil-containing and/or water-containing products.

The product may be a product intended to be used or located on greasy or oily and/or wet surfaces or in humid environments.

The product may have a thickness, i.e. the smallest dimension, in the range 300 to 1000 μm, such as 450 to 900 μm.

The product may have a Bendtsen smoothness in the range of 50 to 4000 ml/min, such as 100 to 1000 ml/min.

The product may have a tensile index in the range of 10 to 60, such as 20 to 60 Nm/g in the machine and cross directions.

The product may have a modulus of elasticity in the range of 3.0 to 6.0 GPA in the machine and cross directions.

The product may have a bending stiffness (Taber 15°) in the range of 20 to 80 mNm, such as 20 to 50 mNm, or 40 to 80 mNm in the machine and cross directions.

In a first exemplary embodiment, the following foaming agents and additives are used in the manufacturing of a three-layered fibrous product:
the top fibrous layer: SDS, PAE and AKD
the middle fibrous layer: PVA
the bottom fibrous layer: SDS and AKD

In a second exemplary embodiment, the following foaming agents and additives are used in the manufacturing of a three-layered fibrous product:
the top fibrous layer: PVA and AKD
the middle fibrous layer: SDS, PAE and AKD
the bottom fibrous layer: PVA and AKD

In a third exemplary embodiment, the following foaming agents and additives are used in the manufacturing of a three-layered fibrous product:
the top fibrous layer: SDS, PAE and AKD
the middle fibrous layer: SDS
the bottom fibrous layer: PVA

Turning now to the drawings:

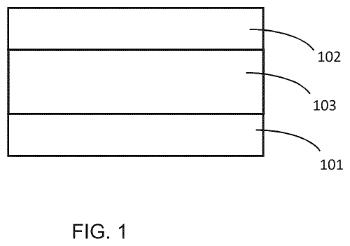

FIG. 1 schematically illustrates a multi-layered fibrous product in accordance with at least some embodiments of the present invention. The product comprises a first fibrous layer 101, which is the lowermost fibrous layer, a second fibrous layer 102, which is the uppermost fibrous layer, and an inner fibrous layer 103 between the first fibrous layer 101 and the second fibrous layer 102.

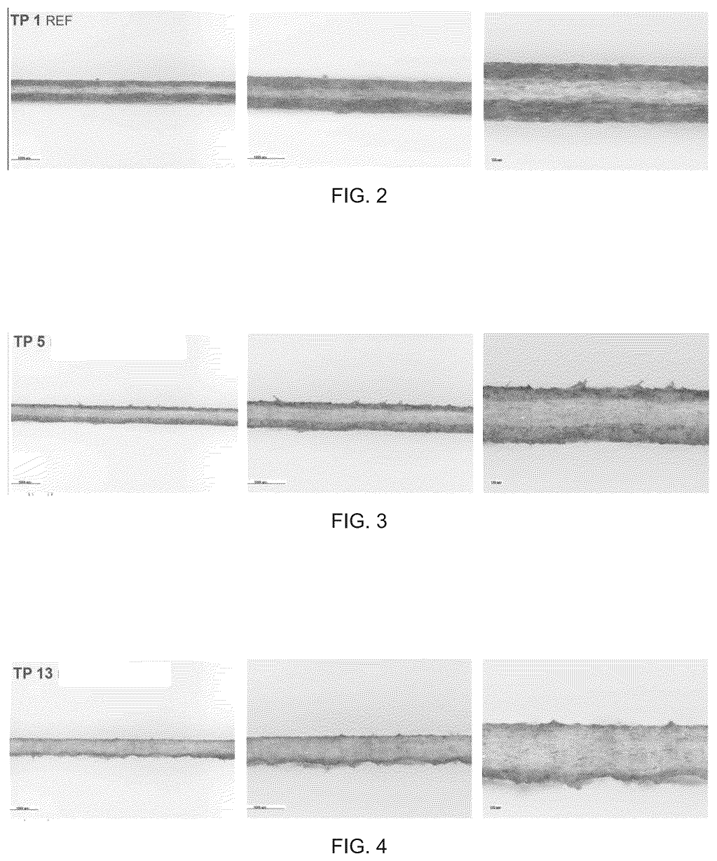

FIG. 2 (reference) shows a stereomicroscope image of a three-layer structure, which was obtained by foam forming, by using SDS as the foaming agent. Scales: 1000 μm (left), 1000 μm (middle), and 100 μm (right).

FIG. 3 shows a stereomicroscope image of a three-layer structure, which was obtained by foam forming, by using PVA as the foaming agent, AKD as the hydrophobic agent, and additionally using a retention aid. Scales: 1000 μm (left), 1000 μm (middle), and 100 μm (right).

FIG. 4 shows a stereomicroscope image of a single-layer structure, which was obtained by foam forming, by using PVA as the foaming agent, AKD as the hydrophobic agent, and additionally using a retention aid. Scales: 1000 μm (left), 1000 μm (middle), and 100 μm (right).

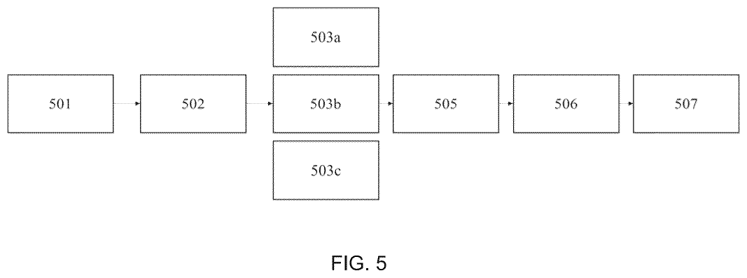

FIG. 5 shows a flow chart illustrating process steps for manufacturing a multi-layered foam-formed product according to an embodiment of the present invention.

The method comprises the following steps:
501 preparing a fibrous stock with a fibre consistency of for example 1 to 3%
502 treating the stock, for example by refining, by adjusting pH and/or by adding chemicals, such as PAE, retention aids, MFC, pigments, and any mixtures thereof
503a, 503b, 503c preparing foams 504a, 504b, 504c (not shown), respectively, from the treated stock
505 forming the foams 504a, 504b, 504c, to obtain a multi-layered foam-formed structure
506 hot-pressing the multi-layered foam-formed structure, from one or both sides
507 optionally finishing, such as coating, printing, cutting, and/or packing

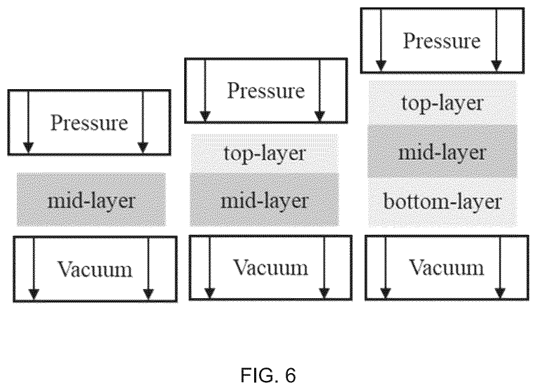

FIG. 6 illustrates foam forming of a three-layered fibrous structure in accordance with at least some embodiments of the present invention. Pressure may be applied from only one side of the fibrous structure or layer. Vacuum may be applied from the opposite side of the fibrous structure or layer. In the left part of FIG. 6, a fibrous layer, which ultimately will be the middle fibrous layer, is formed. In the middle of FIG. 6, a further fibrous layer, which ultimately will be the top fibrous layer, is formed. In the right part of FIG. 6, a still further fibrous layer, which ultimately will be the bottom fibrous layer, is formed, whereby a three-layered fibrous structure is obtained.

### EXAMPLE

The following three-layer samples 1 to 4 were prepared and tested. In all samples, the top fibrous layer and the bottom fibrous layer comprised 50% BHKP (bleached hardwood kraft pulp) and 50% BSKP (bleached softwood kraft pulp), and the middle layer comprised 100% BCTMP (bleached chemithermomechanical pulp).

Sample 1 was a reference sample. SDS was used as the foaming agent. No retention aids, PAE or AKD were used.

In Sample 2, SDS was used as the foaming agent. PAE and AKD were applied as additives.

In Sample 3, PVA was used as the foaming agent. Retention aids and AKD were applied as additives.

In Sample 4, SDS and PVA were used as the foaming agents. Retention aids and AKD were applied as additives.

In these tests, SDS was applied as a surface-active foaming agent (as an anionic surfactant), PVA was applied as a polymeric foaming agent (as a non-ionic polymer), AKD was applied as a hydrophobic agent (as an internal size), PAE was applied as a wet strength agent. A retention aid was applied.

Table 1 provides values for individual layers with the notation top/middle/bottom. Contact angle values refer to surface free energy (Kruss) contact angle in one second (1 s).

TABLE 1

| Sample ID | 1 | 2 | 3 | 4 |
|---|---|---|---|---|
| Fibre stock | 1.4/1.6/1.4 | 1.4/1.6/1.4 | 1.4/1.6/1.4 | 1.4/2.2/1.4 |
| consistency (%) | | | | |
| Foam life as water | 240/270/300 | 255/205/260 | 80/135/140 | 188/170/188 |
| separation volume in | | | | |
| a beaker (ml/10 min) | | | | |
| Foaming agent and its | SDS 0.5 g/l | SDS 0.5 g/l | PVA 5 g/l | PVA 4.6 g/l |
| dosage applied (g per | in all layers | in all layers | in all layers | in top and |
| litre of fibre stock) | | | | bottom layers; |
| | | | | SDS 0.5 g/1 |
| | | | | in middle layer |
| Internal sizing total | none | 8.5 | 5.0 | 5.0 |
| structure (individual | | (7/10/7) | (7/3.5/6) | (10/0/10) |
| layers) (kg/t dry fibre) | | | | |
| Retention aid (kg/t | none | none | (0.4/0.4/0.4) | (0.4/0/0.4) |
| dry fibre) | | | | |
| Wet strength agent | none | PAE | none | none |
| (kg/t dry fibre) | | (3/4.3/3) | | |
| Grammage (g/m²) | 420 | 500 | 490 | 510 |
| Cobb 30 s (g/m²) | >700 | <39 | <36 | <28 |
| Cobb 60 s (g/m²) | na | <46 | na | na |
| Cobb 300 s (g/m²) | na | <56 | na | na |
| Contact angle with | 20° | 112° | 114° | 126° |
| deionised water | | | | |
| Polar and dispersive | polar: 31 | polar: 0 | polar: 1 | polar: 4 |
| components of total | dispersive: 44 | dispersive: 30 | dispersive: 37 | dispersive: 39 |
| surface energy, 0.1 s | | | | |

On the basis of the experiments, the following observations were made: Major increase in hydrophobicity was reached with AKD, as shown by contact angle increase and Cobb value decrease. Reduction of polar components also supports a conclusion that the wettability was reduced when the overall surface energy of the sample was lowered. By carefully chosen surfactant, hydrophobic agent and additives into individual layers of the fibrous multilayer product, the surface and functionality of the product could be modified to comply with eventual further process steps, such as coating, or with end-use applications, such as food packaging.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

### INDUSTRIAL APPLICABILITY

The present invention may be industrially applicable at least in the manufacturing of moulded fibrous products.

### ACRONYMS

SDS sodium dodecyl sulphate
PVA polyvinyl alcohol
AKD alkyl ketene dimer
PAE polyamide-epichlorohydrin
MFC microfibrillated cellulose
APG alkyl polyglycoside
BHKP bleached hardwood kraft pulp
BSKP bleached softwood kraft pulp
BCTMP bleached chemithermomechanical pulp

### REFERENCE SIGNS LIST

101 first fibrous layer
102 second fibrous layer
103 inner fibrous layer
501 preparing a fibrous stock with a fibre consistency of for example 1 to 3%
502 treating the stock, for example by refining, by adjusting pH and/or by adding chemicals, such as PAE, retention aids, MFC, pigments, and any mixtures thereof
503a, 503b, 503c preparing foams 504a, 504b, 504c (not shown), respectively, from the treated stock
505 forming the foams 504a, 504b, 504c, to obtain a multi-layered foam-formed structure
506 hot-pressing the multi-layered foam-formed structure, from one or both sides
507 optionally finishing, such as coating, printing, cutting, and/or packing

1. A method comprising:
in a mould, forming a multi-layered foamed fibrous structure from foamed fibrous compositions, wherein each of the foamed fibrous compositions comprises cellulosic fibres, water, air, and at least one foaming agent;
dewatering the foamed fibrous structure to obtain a dewatered structure; and
hot-pressing the dewatered structure, to obtain a moulded fibrous product,
wherein said at least one foaming agent comprises at least one surface-active foaming agent and/or at least one polymeric foaming agent, and
wherein at least one of the foamed fibrous compositions comprises a hydrophobic agent.

2. The method according to claim 1, wherein each layer of the multi-layered foamed fibrous structure is formed from a respective foamed fibrous composition.

3. The method according to claim 1, wherein each foamed fibrous composition comprises, independently from each other, at least one surface-active foaming agent and/or at least one polymeric foaming agent.

4-7. (canceled)

8. The method according claim 1, wherein
at least one of the foamed fibrous compositions comprises at least 0.5 wt-% of a non-ionic polymer as a foaming agent, calculated from the weight of dry fibres in said foamed fibrous composition, and
at least one of the foamed fibrous compositions comprises at least 0.1 wt-% of an anionic surfactant as a foaming agent, calculated from the weight of dry fibres in said foamed fibrous composition.

9. The method according to claim 8, wherein said at least one non-ionic polymer is selected from the group consisting of: polyvinyl alcohol (PVA), polyethylene glycol dodecyl ether (Brij), polyethylene glycol sorbitan monolaurate (Tween 20), PEG-6 lauramide, alkyl polyglucosides (APG), fatty alcohol ethoxylates, alkylphenol ethyxolates, fatty acid ethyxolates, fatty amide ethyxolates, alkyl glucosides, sugar based non-ionic polymers such as sorbitan alkanoates, sorbitan fatty acid esters (Span), and combinations thereof.

10. The method according to claim 8, wherein said at least one anionic surfactant is selected from the following-group consisting of: sodium dodecyl sulphate, alpha-olefin sulphonates, alkyl sulphates, alkylbenzene sulphonates, alkyl ethersulphates, taurates, isethionates, and combinations thereof.

11. The method according to claim 8, wherein at least one of the foamed fibrous compositions comprises at least 0.5 wt-% of polyvinyl alcohol, calculated from the weight of dry fibres in said foamed fibrous composition.

12. (canceled)

13. The method according to claim 1, wherein at least two of the foamed fibrous compositions further comprises a hydrophobic agent or a sizing agent.

14. (canceled)

15. The method according to claim 1, wherein the hydrophobic agent is included at least in a top fibrous layer multi-layered foamed fibrous structure.

16. The method according to claim 1, wherein the hydrophobic agent is included at least in an inner fibrous layer.

17. (canceled)

18. The method according to claim 1, wherein said hydrophobic agent is alkyl ketene dimer (AKD).

19. The method according to claim 1, wherein at least one of the foamed fibrous compositions comprises at least 0.1 wt-% of the hydrophobic agent, calculated from the weight of dry fibres in said foamed fibrous composition.

20. (canceled)

21. The method according to claim 1, wherein at least one of the foamed fibrous compositions comprises a surface-active foaming agent, a hydrophobic agent and a wet strength agent.

22-24. (canceled)

25. The method according to claim 1, wherein the multi-layered foamed fibrous structure comprises at least three fibrous layers, and
wherein at least one of the foamed fibrous compositions comprises SDS as a surface-active foaming agent, AKD as a hydrophobic agent and PAE as a wet strength agent.

26. The method according to claim 1,
wherein the multi-layered foamed fibrous structure comprises a top layer,
at least one middle layer, and a bottom layer,
wherein the foamed fibrous compositions for the top and the bottom layers comprise a non-ionic polymer as a foaming agent, and
the foamed fibrous composition for the at least one middle layer comprises an anionic surfactant as a foaming agent, and
the foamed fibrous composition for the top layer further comprises a hydrophobic agent and/or the foamed fibrous composition for the bottom layer further comprises a hydrophobic agent.

27. The method according to claim 1,
wherein the multi-layered foamed fibrous structure comprises a top layer,
at least one middle layer, and a bottom layer,
wherein the foamed fibrous compositions for the top and the bottom layers comprise an anionic surfactant as a foaming agent, and
the foamed fibrous composition for the at least one middle layer comprises a non-ionic polymer as a foaming agent, and
the foamed fibrous composition for the at least one middle layer further comprises a hydrophobic agent.

28. (canceled)

29. A moulded multi-layered fibrous product obtained by the method according to claim 1.

30. The moulded multi-layered fibrous product according to claim 29, wherein each fibrous layer has a dry grammage in the range 30 to 700 g/m².

31-33. (canceled)

34. The moulded multi-layered fibrous product according to claim 29, wherein the multi-layered fibrous product is a food or liquid packaging or a food or liquid serving product or a part thereof, and wherein at least the top fibrous layer configured to be in contact with the food or liquid comprises a hydrophobic agent to impart barrier properties.

35. (canceled)

36. The moulded multi-layered fibrous product according to claim 29, wherein the product has a Bendtsen smoothness in the range of 50 to 4000 ml/min and a bending stiffness (Taber 15°) in the range of 40 to 80 mNm in the machine and cross directions.

37-39. (canceled)
